(19) United States
(12) Patent Application Publication
(10) Pub. No.: US 2014/0132502 A1
(43) Pub. Date: May 15, 2014

(54) METHOD FOR QUICKLY SELECTING A FUNCTION FROM A SMART DEVICE

(71) Applicant: Cheng Kuang YANG, Taichung City (TW)

(72) Inventor: Cheng Kuang YANG, Taichung City (TW)

(21) Appl. No.: 14/073,582

(22) Filed: Nov. 6, 2013

(30) Foreign Application Priority Data
Nov. 12, 2012 (TW) 101141958

(51) Int. Cl. G06F 3/01

(52) U.S. Cl. CPC G06F 3/01
USPC 345/156

(57) ABSTRACT

A method for quickly selecting a function from a smart device having a CPU and motion sensor. The method includes the steps: detecting an action mode of the smart device by the motion sensor and transmitting an action signal corresponding to the action mode to the CPU; matching the action signal to a predetermined function corresponding to the action signal by the CPU; and executing the predetermined function by the CPU according to an execution signal. In the method, the action data corresponding to the action modes of the smart device are built in an action database, and the predetermined function corresponding to the action mode of the smart device is executed in accordance with the action data by means of the motion sensor of the smart device which detects the action mode of the smart device so that the predetermined function can be quickly switched to and then executed.

### PRIORITY CLAIM

The present application claims priority to Taiwan Patent Application No. 101141958, filed on Nov. 12, 2012, which said application is incorporated by reference in its entirety herein.

### BACKGROUND OF THE INVENTION

1. Field of The Invention

The present invention relates to a smart device, and in particular, to a method, a recording medium and a computer program product for quickly selecting a function from a smart device.

2. Background of The Invention

As technologies progress and the quality of life improves continuously, smart devices, such as laptop computers, tablet PCs and smart phones, have become commonly used products in our daily life. Smart devices have the feathers of compact size and portability and the functions of making a call, accessing to the Internet, watching videos, listening to music, playing games, etc., hence have become indispensable electronic products in our life.

Currently, the smart devices have so many functions that may take a long time either to select a function ready for use from the idle state, or to switch between the states of using one function to another function because of time consuming in terms of selecting functions/applications. For instance, when a user sees a beautiful scene and wants to take photographs by using the camera function but the smart device is in the idle state or in the state of using another function, multiple steps of operations are required to switch to the desired camera function. As a consequence, the beautiful scene, which is usually fleeting, may not be captured due to the latency.

### BRIEF SUMMARY OF THE INVENTION

In view of the above, the object of the present invention is to provide a method, a recording medium and a computer program product for quickly selecting a function from a smart device, wherein the action data corresponding to the action modes of the smart device are built in an action database, and a predetermined function corresponding to an action mode of the smart device is executed in accordance with the action data by means of a motion sensor of the smart device which detects the action mode thereof so that the predetermined function can be quickly switched to and then executed.

A first aspect of the present invention is to provide a method for quickly selecting a function from a smart device having a CPU and a motion sensor, the method comprising the steps of: detecting an action mode of the smart device by the motion sensor so as to transmit an action signal corresponding to the action mode to the CPU; matching the action signal to a predetermined function corresponding to the action signal by the CPU; and executing the predetermined function by the CPU according to an execution signal.

A second aspect of the present invention is to provide a recording medium with a program stored therein. When the program is loaded from the recording medium and executed by a smart device, the smart device can implement the method provided in the first aspect of the present invention.

A third aspect of the present invention is to provide a computer program product. When the program is loaded and executed by a smart device, the smart device can implement the method provided in the first aspect of the present invention.

### BRIEF DESCRIPTION OF THE DRAWINGS

FIG. 1 is a system block diagram of a smart device of the present invention.

FIG. 2 is a flow chart of a method for quickly selecting a function from a smart device of the present invention.

### DETAILED DESCRIPTION OF THE INVENTION

A preferred embodiment of the present invention is described hereinafter with reference to the accompanying drawings.

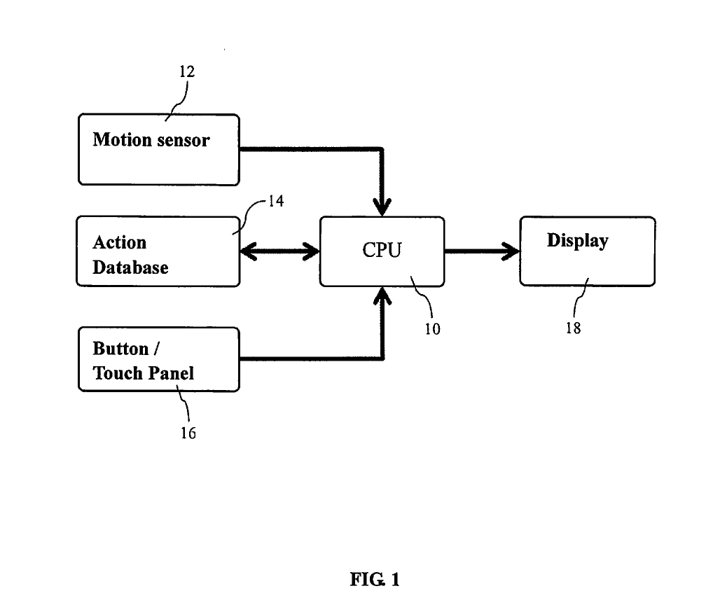

FIG. 1 is a system block diagram of a smart device of the present invention. In FIG. 1, the smart device has a CPU (Center Processor Unit) 10, a motion sensor 12, an action database 14, a button/touch panel 16 and a display 18.

The motion sensor 12 detects an action mode of the smart device and transmits an action signal corresponding to the action mode to the CPU 10. The action data of the smart device, namely, the action modes and their corresponding predetermined functions as shown in Table 1, are built in the action database 14. The CPU 10 reads out the action data from the action database and compares the action signal therewith to determine whether the detected action mode of the smart device corresponds to any one of the predetermined functions according to Table 1. It is understood that the action modes and the predetermined functions in Table 1 are drawn simply for illustrative purposes and shall not be used to limit the scope of the present invention.

TABLE 1

| ACTION MODES | PREDETERMINED FUNCTIONS |
|---|---|
| Shaking rightward once | Facebook |
| Shaking rightward twice | Camera |
| Shaking leftward once | Music |
| Shaking leftward twice | Telephone |
| Revolution upper rightward | Recorder |
| Revolution lower rightward | Game A |
| Revolution upper leftward | Game B |
| Revolution lower leftward | Game C |
| Knocking the device once | Memo |
| Knocking the device twice | Navigation |
| Shaking upward once | APP-A |
| Shaking upward twice | APP-B |
| Shaking downward once | Webpage |
| Shaking downward twice | . . . |
| Shaking leftward and rightward | . . . |
| Shaking rightward and leftward | . . . |

When a user operates the button/touch panel 16, the button/touch panel 16 transmits an execution signal to the CPU 10. The CPU 10 will then display the function or procedure to be executed on the display 18.

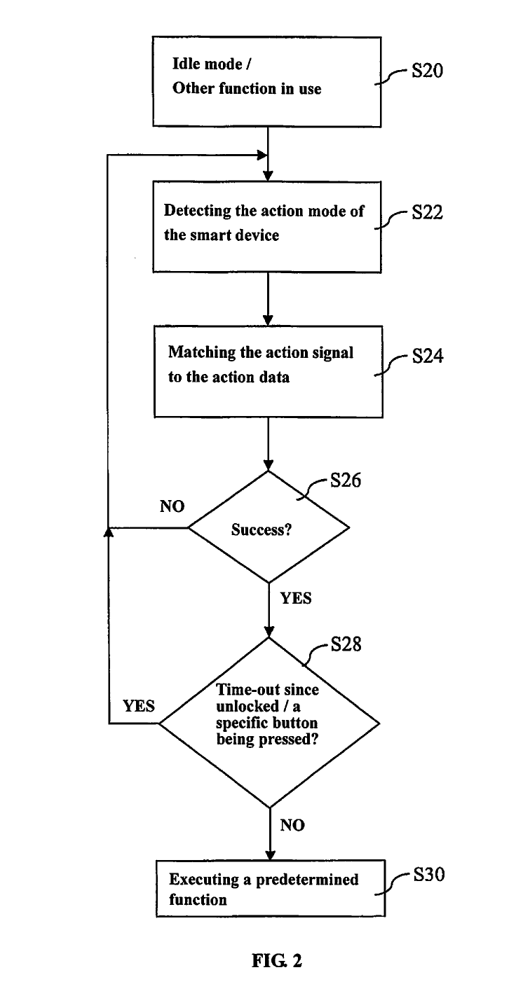

FIG. 2 is a flow chart of a method for quickly selecting a function from a smart device of the present invention. The processing steps of FIG. 2 may be explained with reference to the elements of FIG. 1 and Table 1.

In FIG. 2, when the smart device is currently in the idle state or in the state of using another function, for example, playing music, the motion sensor 12 detects the current action mode of the smart device (step S20).

For example, when a user would like to take photographs for the beautiful scene, the user is required to switch the smart device from the idle state or the current state of playing music to the desired camera function. As shown in Table 1, shaking the smart device rightward twice will switch it to the camera function, therefore, the motion sensor 12 detects the action mode that the smart device is being shaken rightward twice and transmits a corresponding action signal to the CPU 10 (step S22).

After receiving the action signal corresponding to that the smart device is being shaken rightward twice, the CPU 10 accesses the action data from the action database 14 and compares the action signal therewith (step S24).

When the CPU 10 compares the action signal with the action data, if the CPU 10 fails to match the action signal to the action data, such as a wrong operation of shaking the smart device rightward thrice, the process goes to step S22 and the motion sensor 12 proceeds to detect the current action mode of the smart device; if the result of comparing the action signal with the action data by the CPU 10 is successful, the CPU 10 is in the stage ready to execute the camera function (step S26).

The smart device or the CPU 10 has a timer (not shown in FIG. 1) which counts a predetermined period of time and sends a time-out signal to the CPU 10 at the end of the predetermined period of time. The CPU 10 determines whether the time-out signal has been received at the time or before the smart device is unlocked or a specific button is down clicked (step S28).

If the CPU 10 received the time-out signal at the time or before a user operates the button/touch panel 16 to conduct the unlock procedure while the smart device is in the idle state, or at the time or before a user down clicks a specific button on the button/touch panel 16 while the smart device is the state of playing music, the process goes to step S22 and the motion sensor 12 proceeds to detect the current action mode of the smart device. If the CPU 10 did not receive the time-out signal, the button/touch panel 16 transmits an execution signal to the CPU 10. When the CPU 10 receives the execution signal, the CPU 10 executes the predetermined function; for example, switching the smart device from the idle state or the state of playing music to camera function, and displaying the graphic user interface of the camera function on the display 18 (step S30).

The method for quickly selecting a function from the smart device of the present invention can be implemented on a smart device performing the steps as described above.

The aforesaid method for quickly selecting a function from a smart device of the present invention can be implemented by writing a computer program, and the computer program can be stored in a recording medium. When the smart device loads the computer program from the recording medium and executes it, the steps of the method shown in the description above and drawings can thus be carried through.

Similarly, the aforesaid method for quickly selecting a function from a smart device of the present invention can be implemented by a computer program product. When the smart device downloads the computer program product from, for example, the Internet and executes it, the steps of the method shown in the description above and drawings can thus be carried through.

The feature of the present invention is to provide a method, a recording medium and a computer program product for quickly selecting a function from a smart device. The action data corresponding to the action modes of the smart device are built in an action database, and according to the action data, a CPU executes the predetermined function corresponding to an action mode detected by a motion sensor of the smart device so that the predetermined function is quickly switched to and executed.

Although the present invention has been explained above in relation to its preferred embodiment and exemplary drawings, it shall not be considered limited thereby. It is to be understood that many possible modifications, omissions and variations can be made by those skilled in the art without departing from the scope of the present invention as hereinafter claimed.

### BRIEF DESCRIPTION OF THE REFERENCE NUMERALS

10 CPU
12 motion sensor
14 action database
16 button/touch panel
18 display

What is claimed is:

1. A method for quickly selecting a function from a smart device having a CPU and a motion sensor, the method comprising the steps of:
detecting an action mode of the smart device by the motion sensor and transmitting an action signal corresponding to the action mode to the CPU;
matching the action signal to a predetermined function corresponding to the action signal by the CPU; and
executing the predetermined function by the CPU according to an execution signal.

2. The method as in claim 1, wherein while the smart device is in the idle state, the execution signal is transmitted to the CPU when the unlock procedure of the smart device is conducted.

3. The method as in claim 1, wherein while the smart device is in the state of using a function, the execution signal is transmitted to the CPU when a specific button of the smart device is operated.

4. The method as in claim 1, wherein the CPU compares the action signal with the action data built in an action database of the smart device to determine whether a predetermined function corresponding to the action signal is provided.

5. The method as in claim 1, wherein before executing the predetermined function, the CPU determines whether the execution signal is received within a predetermined period of time.
